(19) United States
(12) Patent Application Publication
(10) Pub. No.: US 2004/0095740 A1
(43) Pub. Date: May 20, 2004

(54) Plane lighting structure for dual displays

(75) Inventors: Che-Kuei Mai, Hsinchu (TW); Ching-Huang Lin, Ma-Gong City (TW)

Correspondence Address: LOWE HAUPTMAN GOPSTEIN GILMAN & BERNER, LLP, Suite 310, 1700 Diagonal Road, Alexandria, VA, 22314, US

(73) Assignee: Toppoly Optoelectronics Corp.

(21) Appl. No.: 10/298,586

(22) Filed: Nov. 19, 2002

(51) Int. Cl. G01D 11/28

(52) U.S. Cl. 362/27; 362/31

(57) ABSTRACT

A plane lighting structure for dual displays includes two light sources and a light guide plate. The light guide plate has two light-transmissive surfaces that can guide the light rays emitted from two light sources toward two light-emitting surfaces at the opposite ends of the guide plate located between two light sources. There are two different transparent media in the light guide plate, one is located between two light-transmissive surfaces and the other is located between two light-emitting surfaces and two light-transmissive surfaces.

### BACKGROUND OF THE INVENTION

1. Field of the Invention

The present invention generally relates to a plane lighting structure, and more particularly to a plane lighting structure for dual displays.

2. Description of the Prior Art

Many display devices need the plane light sources such as LCD monitors and scanners. It is well known to use an incandescent lamp or LED as a point light source or a cold cathode fluorescent lamp (CCFL) as a line light source. There are two direct methods to form the plane light source, one is to assemble an array of the above-mentioned point light source, and the other is to assemble a row of the above-mentioned line light source. However, such methods will not only waste the power supply, but also be detrimental to the cost reduction.

It is advantage to form the plane light source by using the light guide plate such as the wedge plate 10 shown in FIG. 1A or the flat plate 20 shown in FIG. 1B. These light guide plates can guide the light rays emitted from the light sources 12,22 toward the liquid crystal cell array (not shown in these figures) through the reflecting slant portions (V-cut) or the convex/concave dots. Presently, there are many improvements on the wedge light guide plate 10 in FIG. 1A, such as US patent publication number 20020005991, which enhances the uniformity by putting a prism sheet above the light guide plate to avoid the light rays emitted directly into the eyes of user from the light source.

However, there are still some drawbacks in above two methods for forming the plane light source. First, as shown in the wedge plate 10 in FIG. 1A, the brightness of the light source 12 is usually focused on the position that is about one-third length of the light guide plate close to the light source 12. It causes the unbalanced light uniformity for the left and right sides of the wedge light guide plate 10. Besides, as shown in FIG. 1B, to use the flat guide plate 20 with the two light sources 22 can decrease the above-mentioned problem but the brightness at the midst of the flat guide plate 20 is darkest.

Another method for resolving the light uniformity as shown in FIG. 2, provided by Fujitsu, is to use the hollow structure of the light guide plate. The light rays are emitted from the light sources 30 at the both lateral sides of the light guide plate into the panel of the LCD monitor through the lens 32, two pieces of the lens 34 with the specified reflection index, two pieces of the control sheets 36 with the specified refraction index, and the lens set 38. Besides, two reflection sheets 40 can be affixed on the bottom of two pieces of the lens 34 in order to increase the brightness. However, this complex plane lighting structure not only increases the cost and the difficulty of the production, but also reduces the yield of the production.

### SUMMARY OF THE INVENTION

In the light of the state of the art described above, it is an object of the present invention to provide a light guide plate with two different media for dual displays which is immune to the problems of the conventional plane lighting structure described above and which can increase the brightness of the plane lighting structure because the energy loss of the light rays is reduced in the light guide plate.

It is also an object of this invention to extend the lift life cycle of the plane lighting structure for dual displays.

It is an another object of this invention to provide a hollow light guide plate for reducing the energy loss of the light rays to increase the brightness of the plane lighting structure for dual displays.

It is a further object of this invention to decrease the weight of the plane lighting structure for dual displays.

In view of the above and other objects which will become apparent as the description proceeds, there is provided according to a general aspect of the present invention a plane lighting structure for dual displays which includes two light sources; and a light guide plate with two light-transmissive surfaces that can guide the light rays emitted from two light sources toward two light-emitting surfaces at the opposite ends of the light guide plate located between two light sources, wherein the light guide plate has two different transparent media, one is located between two light-transmissive surfaces and the other is located between two light-emitting surfaces and two light-transmissive surfaces.

Base on the idea described above, wherein two light-transmissive surfaces have a plurality of reflecting slant portions.

Base on the aforementioned idea, the plane lighting structure for dual displays further comprises two diffusion sheets located between the light guide plate and two light sources.

Base on the idea described above, the plane lighting structure for dual displays further comprises two lens sets put on two light-emitting surfaces at the opposite ends of the guide plate respectively.

Base on the aforementioned idea, the plane lighting structure for dual displays further comprises a reflection layer affixed on one of two light-emitting surfaces.

Base on the idea described above, wherein the reflection layer has an opening.

There is provided according to a general aspect of the present invention a plane lighting structure for dual displays which includes two light sources; and a light guide plate with two light-transmissive surfaces that can guide the light rays emitted from two light sources toward two light-emitting surfaces at the opposite ends of the light guide plate located between two light sources. The light guide plate further includes a first transparent medium located between two light-transmissive surfaces; and a second transparent medium located between two light-emitting surfaces and two light-transmissive surfaces, wherein the refraction index of the second transparent medium is about 1.

There is provided according to a general aspect of the present invention a plane lighting structure for dual displays which includes a first light-receiving surface that receive the light rays emitted from a first light source; a second light-receiving surface that receive the light rays emitted from a second light source; a first light-transmissive surface that guide the light rays emitted from the first light source toward a first light-emitting surface of the light guide plate; a second light-transmissive surface that guide the light rays emitted from the second light source toward a second light-emitting surface of the light guide plate, wherein a medium is located between the first and second light-transmissive surfaces, then the light rays emitted from the first and second light sources pass through the medium before received by the first and second light-receiving surfaces; and two lens sets put on the first and second light-emitting surfaces of the guide plate respectively.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A illustrates a conventional plane lighting structure with the wedge light guide plate;

FIG. 1B illustrates a conventional plane lighting structure with the plat light guide plate;

FIG. 2 illustrates a conventional plane lighting structure with the hollow light guide plate provided by Fujitsu;

FIG. 3 illustrates the first preferred embodiment of the light guide plate for dual displays according to the present invention;

FIG. 4 illustrates the second preferred embodiment of the light guide plate for dual displays according to the present invention;

FIG. 5 illustrates the third preferred embodiment of the light guide plate for dual displays according to the present invention; and

FIG. 6 illustrates the fourth preferred embodiment of the light guide plate for dual displays according to the present invention, wherein one of the dual displays is large than the other.

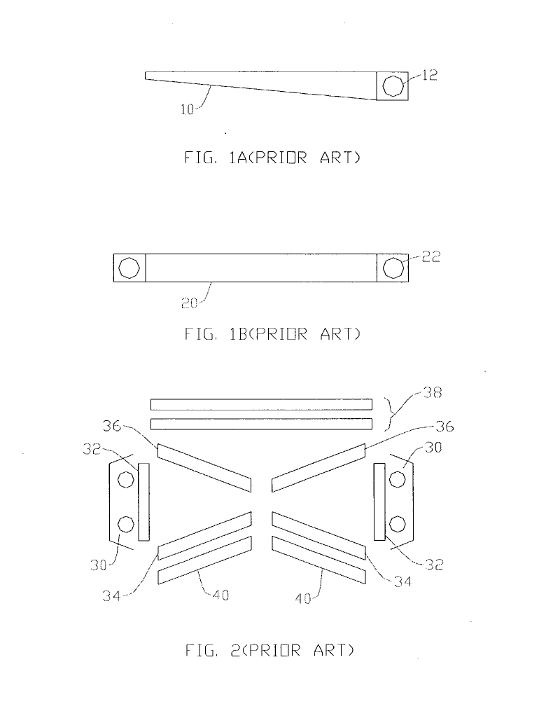

### DESCRIPTION OF THE PREFERRED EMBODIMENT

Some sample embodiments of the present invention will now be described in greater detail. Nevertheless, it should be recognized that the present invention can be practiced in a wide range of other embodiments besides those explicitly described, and the scope of the present invention is expressly not limited except as specified in the accompanying claims.

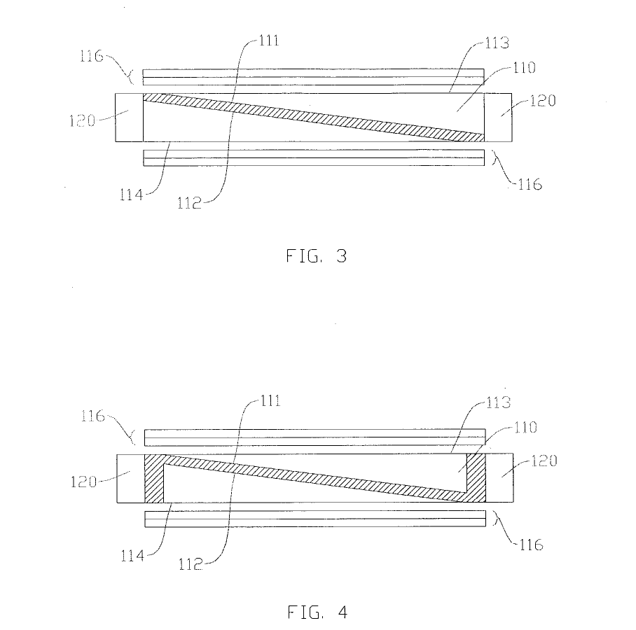

Next, a plane lighting structure for dual displays is illustrated according to this invention. As shown in FIG. 3, there are two light sources 120 at the lateral sides of the light-receiving surfaces of the light guide plate 110. The light sources 120 can be the cold cathode fluorescent lamp (CCFL) or the line light source formed by LED. The light guide plate 110 has the two light-transmissive surfaces 111,112 with a plurality of reflecting slant portions (V-cut) or convex/concave dots to guide the light rays emitted from the light sources 120 toward the two opposite light-emitting light surfaces 113,114. The light refraction index of the transparent media between the two light-transmissive light surfaces 111,112 is different from the light refraction index of the transparent media between the light-emitting light surfaces 113/114 and the light-transmissive surfaces 111/112. A preferred embodiment is that the transparent media between the light-transmissive surfaces 111,112 still use the material of the conventional light guide plate but there are not other media except for the air between the light-emitting light surfaces 113/114 and the light-transmissive surfaces 111/112. In other words, the light rays in the light guide plate 110 only pass mostly through the air whose refraction index is about 1, so the energy loss of the light rays can be lowest. The lens sets 116 are put on the light-emitting surfaces 113,114 of the light guide plate 110 respectively, then the light rays can be emitted uniformly from the light-emitting surfaces 113,114. Usually, the lens set 116 includes a prism sheet, a diffusion sheet, and other possible components.

FIG. 4 is another embodiment according to this invention. It is the only difference between this and the first embodiment of FIG. 3 that the media near the two light-receiving surfaces of the light guide plate 100 and between the light-transmissive surfaces 111,112 are same. But the media between the light-emitting light surfaces 113/114 and the light-transmissive surfaces 111/112 are still the air. The above-mentioned structure can provide the lens set 116 with stronger support.

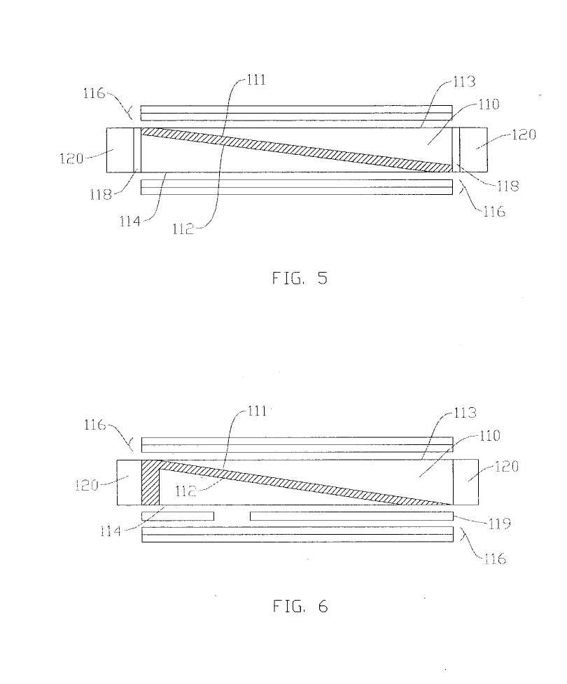

FIG. 5 is the third embodiment of this invention. The difference between this and the first embodiment of FIG. 3 is that two diffusion sheets 118, which are set between the light guide plate 110 and two light sources 120, are affixed on two light-receiving surfaces of the light guide plate 110 respectively. It is the advantage for the affixed diffusion sheets 118 that the light rays emitted from the light sources 120 can be distributed uniformly because the brightness of the both ends and the midst of the cold cathode fluorescent lamp (CCFL) are not the same or the light rays are not emitted uniformly by the light sources 120 formed by the point light sources, LED.

The above-mentioned plane lighting structures for dual displays all used in the same or symmetric display panels. However, it is possible to use the asymmetric display panels in our lives, for example, there are the two display panels, divided into the main display panel and the sub display panel, on both sides of the upper fold of the foldable cell phone. FIG. 6 is the cross-section view for the asymmetric plane light sources and this embodiment can be applied to the above example properly, because the reflection layer 119 can be affixed on the light-emitting surface 114 of the sub display panel. Then the size of the opening is adjusted itself to the size of the panel of the sub display, and it is helpful to use the reflection layer 119 can increase the brightness of the main display panel.

However, the air is one of the media for the light distribution, which the light refraction index is about 1. Hence, other transparent media can be filled into the hollow part of the light guide plate of the present invention if the light reflection indices of the filled medium and the light guide plate are different. The purpose of filled medium is to provide the light guide plate with a stronger support. But the density of the filled medium must be small to reduce the weight of the light guide plate and the energy loss of the light rays.

Although specific embodiments have been illustrated and described, it will be obvious to those skilled in the art that various modifications may be made without departing from what is intended to be limited solely by the appended claims.

What is claimed is:

1. A plane lighting structure for dual displays, comprising:
two light sources; and
a light guide plate with two light-transmissive surfaces that can guide the light rays emitted from said two light sources toward two light-emitting surfaces at the opposite ends of said light guide plate located between said two light sources, wherein said light guide plate has two different transparent media, one is located between said light-transmissive surfaces and the other is located between said two light-emitting surfaces and said two light-transmissive surfaces.

2. The plane lighting structure for dual displays according to claim 1, wherein said two light-transmissive surfaces have a plurality of reflecting slant portions.

3. The plane lighting structure for dual displays according to claim 2 further comprising two diffusion sheets located between said light guide plate and two light sources.

4. The plane lighting structure for dual displays according to claim 2 further comprising two lens sets put on said two light-emitting surfaces at the opposite ends of said guide plate respectively.

5. The plane lighting structure for dual displays according to claim 2 further comprising a reflection layer affixed on one of said two light-emitting surfaces.

6. The plane lighting structure for dual displays according to claim 5, wherein said reflection layer has an opening.

7. A plane lighting structure for dual displays, comprising:
two light sources; and
a light guide plate with two light-transmissive surfaces that can guide the light rays emitted from said two light sources toward two light-emitting surfaces at the opposite ends of said light guide plate located between said two light sources, wherein said light guide plate further includes:
a first transparent medium located between said two light-transmissive surfaces; and
a second transparent medium located between said two light-emitting surfaces and said two light-transmissive surfaces, wherein the refraction index of said second transparent medium is about 1.

8. The plane lighting structure for dual displays according to claim 7, wherein said two light-transmissive surfaces have a plurality of reflecting slant portions.

9. The plane lighting structure for dual displays according to claim 8, wherein said light guide plate has said first medium located between the light-receiving surfaces of said light guide plate.

10. The plane lighting structure for dual displays according to claim 8 further comprising two diffusion sheets located between said light guide plate and two light sources.

11. The plane lighting structure for dual displays according to claim 8 further comprising two lens sets put on said two light-emitting surfaces at the opposite ends of said guide plate respectively.

12. The plane lighting structure for dual displays according to claim 8 further comprising a reflection layer affixed on one of said two light-emitting surfaces.

13. The plane lighting structure for dual displays according to claim 12, wherein said reflection layer has an opening.

14. A plane lighting structure for dual displays, comprising:
a light guide plate having:
a first light-receiving surface that receive the light rays emitted from a first light source;
a second light-receiving surface that receive the light rays emitted from a second light source;
a first light-transmissive surface that guide the light rays emitted from said first light source toward a first light-emitting surface of said light guide plate;
a second light-transmissive surface that guide the light rays emitted from said second light source toward a second light-emitting surface of said light guide plate, wherein a medium is located between said first and second light-transmissive surfaces, then the light rays emitted from said first and second light sources pass through said medium before received by said first and second light-receiving surfaces; and
two lens sets put on said first and second light-emitting surfaces of said guide plate respectively.

15. The plane lighting structure for dual displays according to claim 14, wherein said two light-transmissive surfaces have a plurality of reflecting slant portions.

16. The plane lighting structure for dual displays according to claim 14 further comprising a reflection layer affixed on one of said two light-emitting surfaces.

17. The plane lighting structure for dual displays according to claim 16, wherein said reflection layer has an opening.
